(19) United States
(12) Patent Application Publication
(10) Pub. No.: US 2026/0361229 A1
(43) Pub. Date: Nov. 12, 2026

(54) Capacitive Bridge Transformer with Isolation

(71) Applicant: Wisconsin Alumni Research Foundation, Madison, WI (US)

(72) Inventors: Daniel Ludois, Middleton, WI (US); Mahima Gupta, Madison, WI (US); Patrick Nowakowski, De Pere, WI (US)

(21) Appl. No.: 19/203,772

(22) Filed: May 9, 2025

(51) Int. Cl. H02M 3/335

(52) U.S. Cl. CPC H02M 3/33584

(57) ABSTRACT

A dual active bridge for DC to DC conversion eliminates the use of a conventional transformer in favor of a capacitor network providing weight, cost, and manufacturing advantages.

### STATEMENT REGARDING FEDERALLY SPONSORED RESEARCH OR DEVELOPMENT

### CROSS REFERENCE TO RELATED APPLICATION

### Background of the Invention

The present invention relates to active bridge transformers serving to convert DC electrical power between voltage and current levels and, in particular, to an active bridge transformer that eliminates the need for conventional iron core transformers or large inductors with cores for galvanic isolation.

High-power DC-DC converters are used to change a DC voltage or current level. In one example, such high-powered DC-DC converters may be used to connect renewable energy sources, such as solar and wind, to high-voltage DC power transmission lines.

One common design of a DC-DC converter is the dual active bridge (DAB) which consists of two voltage source inverters (VSIs) whose A C terminals are joined by an isolating transformer. The VSIs may operate to synthesize and rectify signals at high frequencies shrinking the size of the connecting transformer, nevertheless the need for a transformer presents a number of drawbacks including the cost and weight of transformer winding conductors and ferromagnetic core material, operating frequency limits imposed by the core material, conduction losses from circulating reactive power, and the challenges of controlling inductance values in the face of interdependence between cross coupling leakage and magnetizing inductance.

### SUMMARY OF THE INVENTION

The present invention provides a dual active bridge that eliminates interconnecting A C magnetics by using a capacitive bridge capacitively coupling two current source inverters (CSI). The result can be a lighter, more readily manufactured, and less expensive dual active bridge.

More specifically, in one embodiment, the invention provides a capacitive bridge transformer having a first and second terminal for receiving a source of current, a first switch ladder bridging the first and second terminals and having series connected solid-state switching elements connected at a first junction, and a second switch ladder bridging the first and second terminals and having series connected solid-state elements connected at a second junction. The capacitive bridge transformer further has a third and fourth terminal for communicating to a load, a third switch ladder bridging the third and fourth terminals and series connected solid-state switching elements connected at a third junction, and a fourth switch ladder bridging the third and fourth terminals and having series connected solid-state switching elements connected at a fourth junction. A first coupling capacitor connects between and isolates the first and third junctions and a second coupling capacitor connects between and isolates the second and fourth junctions so that the first and second junctions and the third and fourth junctions each face a capacitive impedance. A solid-state switching element controller operates the solid-state switching elements to communicate DC power from the first and second terminals to the third and fourth terminals.

It is thus a feature of at least one embodiment of the invention to provide a DC-DC converter that eliminates or significantly reduces A C magnetic elements and their disadvantages.

The capacitive bridge transformer may further include at least one first current matching capacitors connected between the first junction and the second junction and at least one second current matching capacitors connected between the third junction and the fourth junction.

It is thus a feature of at least one embodiment of the invention to provide both good coupling and a high capacitive impedance connecting the current source inverters.

At least one of the first current matching capacitors and at least one second current matching capacitors may have capacitances between the first junction and second junction and between the third junction and fourth junction respectively controlling at least one of a step up or step down of current between the first and second terminals and the third and fourth terminals.

It is thus a feature of at least one embodiment of the invention to provide a step up/step down capability analogous to that offered by iron core transformers but without A C magnetics.

The capacitive bridge transformer may further include an input inductor in series with at least one of the first and second terminals, and/or an output inductor in series with at least one of the third and fourth terminals providing a current stiff input or output current respectively.

It is thus a feature of at least one embodiment of the invention to present the CSIs with current stiff input voltage and output load.

The capacitive bridge transformer may further include a third coupling capacitor connected between and isolating the first and fourth junctions and a fourth coupling capacitor connected between and isolating the second and third junctions.

It is thus a feature of at least one embodiment of the invention to provide improved component redundancy.

The solid-state switching element controller may switch the solid-state switching elements at a frequency in excess of 2 kHz.

It is thus a feature of at least one embodiment of the invention to permit the use of smaller coupling capacitors through high-frequency operation

These particular objects and advantages may apply to only some embodiments falling within the claims and thus do not define the scope of the invention.

### BRIEF DESCRIPTION OF THE DRAWINGS

FIG. 1 is a schematic diagram of one embodiment of the invention providing for a three-phase, dual active bridge employing opposed current source inverters (CSIs) formed each of three ladders of bidirectional solid-state switching elements (each ladder formed of a pair of insulated gate bipolar transistors) and communicating between each other by coupling capacitors Cₘ flanked by energy current matching capacitors Cₚ and Cₛ respectively, the latter each in a Y configuration;

FIG. 2 is a schematic representation of a monolithic bidirectional solid-state switching element that may replace the pair of insulated gate bipolar transistors of FIG. 1;

FIG. 3 is a detail of FIG. 1 showing an alternative Δ-configuration of the current matching capacitors;

FIG. 4 is a simplified block diagram of the elements of FIG. 1 showing an ability to interconnect multiple current source inverters together in various configurations, for example, a single current source inverter on the left side to either of two current source inverters on the right side, the latter of which can be used independently;

FIG. 5 is a simplified representation of a two-phase version of the circuit of FIG. 1 showing cross connected capacitors for improved component failure resistance;

FIG. 6 is a figure similar to that of FIG. 1 showing a two-leg or single phase version of the present circuit; and

FIG. 7 is a figure similar to that of FIG. 1 showing a circuit for single directional power flow from left to right as depicted.

### DETAILED DESCRIPTION OF THE PREFERRED EMBODIMENT

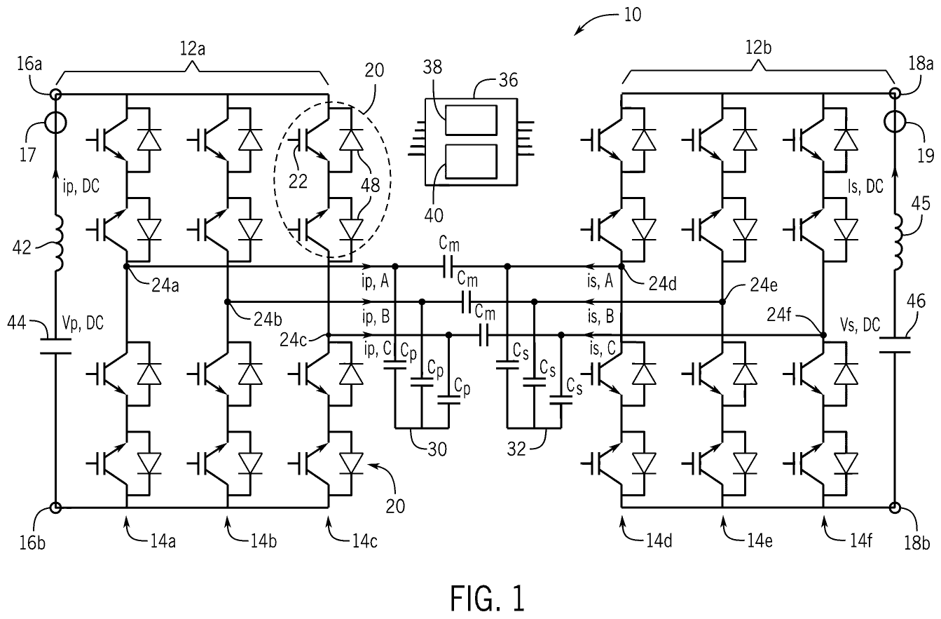

Referring now to FIG. 1, a three-phase dual active bridge 10 of the present invention may provide first and second current source inverters 12a and 12b. Each current source inverter 12 includes three ladders 14, specifically ladders 14a-14c connected in parallel across input terminals 16a and 16b (for CSI 12a) or ladders 14d-14f connected in parallel across output terminals 18a and 18b (for CSI 12b). It will be recognized that the terms input and output in this context are simply for descriptive clarity and that the circuit of FIG. 1 may work equally in a forward or reverse direction with respect to power flow and also in a single rather than three phase design.

Each ladder 14 may consist of two series connected bidirectional switching elements 20. In one embodiment, each bidirectional switching element 20 may be constructed of two opposed and series connected insulated gate bipolar transistors (IGBT) 22a and 22b or MOSFETs or the like, individually shunted by outwardly facing bypass diodes. The bidirectional switching elements 20 of each ladder of the ladders 14a-14f are connected at respective junctions 24a-24c for CSI 12a and 24d-24f for CSI 12b.

Pairs of corresponding junctions 24a and 24d, 24b, and 24e, and 24c and 24f are connected by coupling capacitors Cₘ allowing power flow between the CSIs 12. Each of the junctions 24a-24c also communicates to a common point 30 through current balance capacitors Cₚ. Similarly each of the junctions 24d-24f communicates to a different common point 32 through current matching capacitors Cₛ. These connections of the current matching capacitors Cₚ and Cₛ will be termed Y-configuration connections generally describing their topology.

A switching circuit 36 communicates with and controls each of the bidirectional elements 22 switching each bidirectional switching element 20 between an “on” state (conducting current) or “off” state (blocking current). For CSI 12a, when power flow is from left to right, the switching circuit 36 controls the bidirectional switching elements 22 to convert a DC current through terminals 16a and 16b into a three-phase A C signal having corresponding phases at junctions 24a, 24b, and 24c. The 3-phase CSI legs will switch in a 6-step sequence as is known in the art to facilitate a square-like current at 24a, 24b, 24c, and always adhere to one upper and one lower device being “on” to preserve the input terminal current path. The A C current waveform at each junction 24 will be 120 degrees apart among 24a, 24b, 24c. These coarse approximations of AC waveforms are integrated (low-pass filtered) as they pass between the CSIs 12 through current balancing Cₚ, Cₛ and coupling capacitances Cₘ. Typically the AC waveforms are synthesized at step frequencies in excess of 1 kHz and typically in excess of 10 kHz allowing the values of Cₘ to be minimized while providing good current transmission. The switching circuit 36 may be discrete logic or may provide an electronic computer having processors 38 executing a stored program 40.

The received three-phase power, in this example of rightward power flow, is then synchronously demodulated by CSI 12b switching the positive cycles current of each waveform to terminal 18a and the negative cycles of current to terminal 18b to produce rectified DC power across terminals 18a and 18b. As discussed above, this process may also be performed in reverse with power flowing from CSI 12b to CSI 12a as will be generally understood to those in this art from the above description.

Generally, the necessary switching of the bidirectional elements 20 in the CSI 12a will be shifted in phase with respect to the switching of the bidirectional elements 20 in the CSI 12b.

The power transmission provided by the dual active bridge 10 will be a function of capacitances Cₘ, Cₚ, and Cₛ as follows:

$$P = \frac{\frac{1}{{C}_{p}} \frac{1}{{C}_{s}}}{\frac{1}{{C}_{p}} + \frac{1}{{C}_{m}} + \frac{1}{{C}_{s}}} \frac{{I}_{p , DC} {I}_{s , DC}}{f s w} δ ( 2 - 3 δ )$$

where:
P is the power transfer,
I_{p,DC} is the primary input (output) current at terminals 16 measured by current sensor 17,
I_{s,DC} is the secondary output (input) current at terminals 18 measured by current sensor 19,
f_{SW} is switching frequency,
δ is the phase difference being variable as needed to accommodate active and reactive power flow.

A step up in voltage through the dual active bridge 10 will generally be a function of:

$$\frac{{V}_{s}}{{V}_{p}} = \frac{{C}_{x} {f}_{S W} {R}_{L}}{δ ( 2 - 3 δ )}$$

matching the inverse of the step up in current of:

$$\frac{{I}_{p}}{{I}_{s}} = \frac{{C}_{x} {f}_{S W} {R}_{L}}{δ ( 2 - 3 δ )}$$

where:
Vₛ is the secondary voltage,
Vₚ is the primary voltage,
Iₛ is the secondary current,
Iₚ is the primary current,

$${C}_{x} is \frac{\frac{1}{{C}_{p}} \frac{1}{{C}_{s}}}{\frac{1}{{C}_{p}} + \frac{1}{{C}_{m}} + \frac{1}{{C}_{s}}}$$

and
R_{L} is the effective output load resistance

$$( {R}_{L} = \frac{{V}_{s , DC}}{{I}_{s , DC}} ) .$$

Importantly, each of the CSIs 12 may outwardly face a current stiff impedance, being, in the case when power flows from the left to the right in FIG. 1, a current stiff power source connected to terminals 16 and a current stiff load connected to terminals 18. In this context a current stiff source is defined as one in which the instantaneous change in current with time (di/dt) that is less than 60% of the average value of Ip or Is during the switching period 1/f_{SW}. This is accomplished by placement of a series inductor or external current control at the DC terminals of the CSIs

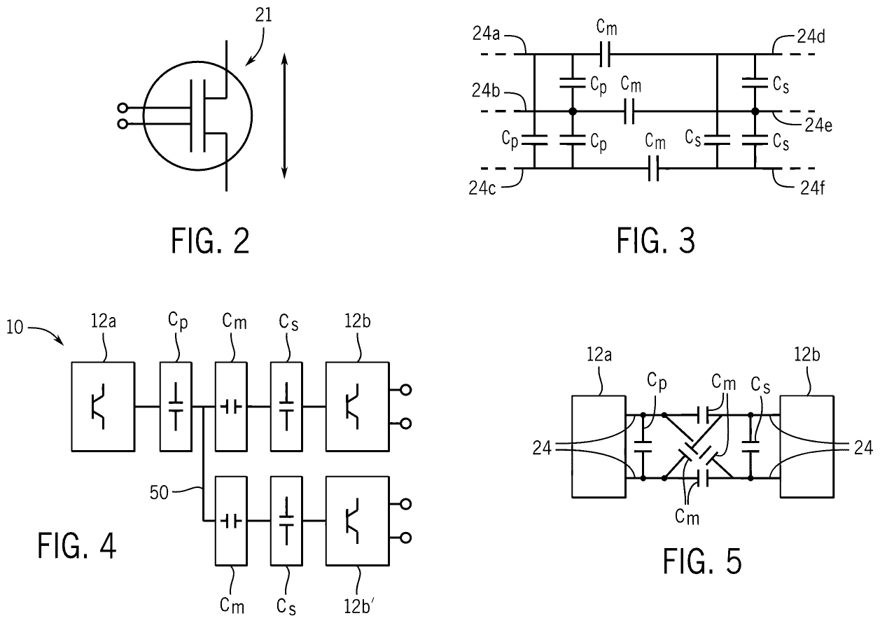

Referring now to FIGS. 1 and 2, it will be appreciated that the bipolar switching elements 20, for example, constructed of opposed insulated gate bipolar transistors 22 and counter facing shunting diodes 48 (per FIG. 1) may be replaced with a monolithic bidirectional field effect transistor 21 providing bidirectional operation in a single device. An example such device is taught by PCT application WO2024/076471 entitled “High-Efficiency Drive Circuit and Bidirectional FET” hereby incorporated by reference. These bidirectional devices may use wide bandgap semiconductor materials such as silicon carbide (SIC) or gallium nitride (GaN)

Referring now to FIG. 3, Y-connected capacitors Cₚ and Cₛ may alternatively be connected in a so-called Δ configuration in which each of the junctions 24a-24c communicate with both of two other of the junctions 24a-24c through individual capacitors Cₚ. Similarly each of the junctions 24d-24f communicate to both of two other junctions 24d-24f through individual current matching capacitors Cₛ.

An input CSI 12a may provide power to multiple output CSIs 12b, 12b′ by providing a branch 50 after the capacitors Cₚ leading to different sets of coupling capacitors Cₘ followed by different sets of capacitances Cₛ and distinct output CSIs 12b and 12b′.

Because of the bidirectional nature of the dual active bridge 10 it will be appreciated that the multiple CSIs 12b and 12b′ may alternatively act as inputs to provide power to a single CSI 12a having an output connected to a load. More generally such a technique may be used to interconnect one or more input CSIs 12 to one or more output CSIs 12.

Referring now to FIG. 5, improved redundancy against component failure can be obtained through the addition of coupling capacitors Cₘ connecting from each of the junctions 24 on the input CSI 12a to every junction 24 on the output CSI 12b.

Generally, the CSIs 12a and 12b each face a capacitive impedance from capacitances Cₘ, Cₚ, and Cₛ being defined as an impedance presenting a phase angle within 10° of a pure capacitance.

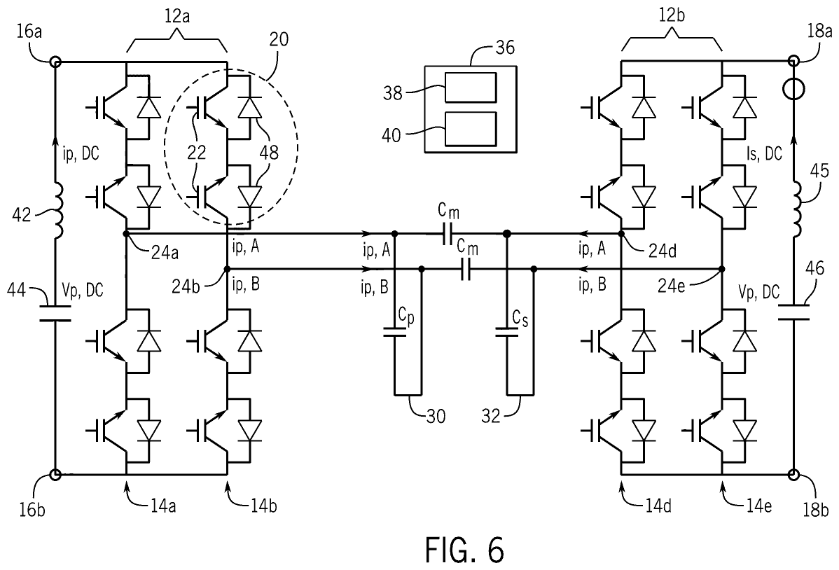

FIG. 6 provides a schematic representation of a variation of the schematic of FIG. 1 for 2-leg, single phase operation eliminating ladders 14c and 14f and the corresponding capacitances Cₚ, Cₛ, and Cₘ associated with those ladders but otherwise operating analogously with the appropriate change in switching sequence. In this representation, the CSI legs will switch in a 2-step sequence as is known in the art to facilitate a square-wave current at 24a, 24b and always adhere to only one upper and one lower device being “on” to preserve the input terminal current path. The AC current waveform at each junction 24 will be 180 degrees apart among 24a, 24b. In this case the current waveforms will be a square wave between the CSIs. This phase shift may be, for example, ⅙ of the period of the switching cycle but more generally will be adjustable to accommodate active and reactive power flow.

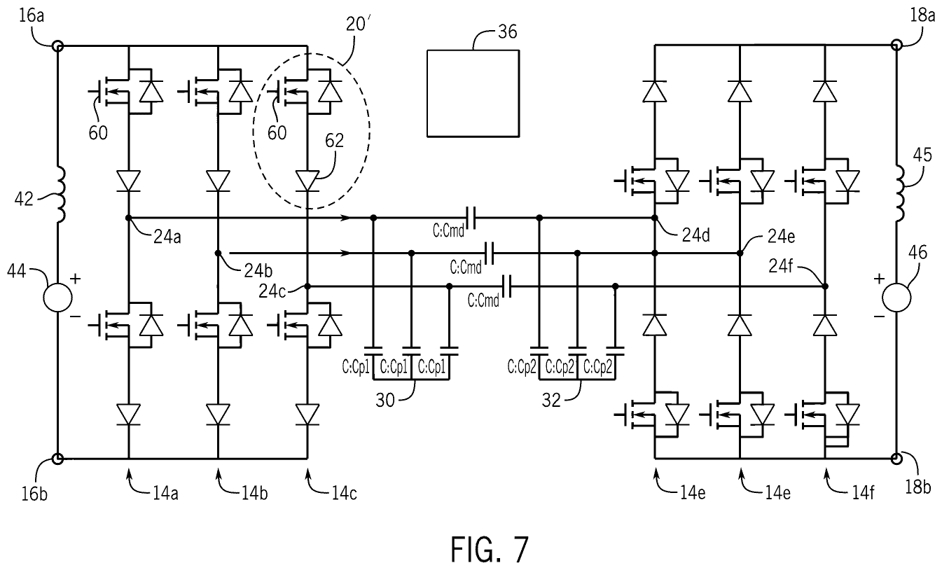

A unidirectional version of the circuit is shown in FIG. 7 where the bidirectional switching elements 20 are replaced with switching elements 20′ each comprising a single unidirectional MOSFET transistor in series with a diode 62 such that current may be sourced through the upper switching elements 20′ to each of the junctions 24a, 24b, 24c, and received through the lower switching elements 20′ from each of the junctions 24a, 24b, 24c, while current may be received from the upper switching elements 20′ from each of the junctions 24d, 24e, 24f and sourced from the lower switching elements 20′ to each of the junctions 24d, 24e, 24f. In this circuit power flows from the left side to the right side only, and reverse power flow is not possible.

It will be appreciated that the present invention provides galvanic isolation which is an electrical isolation excluding capacitive or inductive coupling, generally allowing differing ground potential of different isolated circuits without promoting current flow.

Certain terminology is used herein for purposes of reference only and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

References to processors or circuitry for executing programs should be broadly understood to include conventional von Neumann processors as well as state machines or the like any of which may be implemented in a variety of forms including conventional integrated circuits, FPGA's microprocessors discrete logic and the like.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A capacitive bridge transformer comprising:
a first and second terminal for receiving a source of current;
a first switch ladder bridging the first and second terminals and having series connected solid-state switching elements connected at a first junction;
a second switch ladder bridging the first and second terminals and having series connected solid-state elements connected at a second junction;
a third and fourth terminal for communicating to a load;
a third switch ladder bridging the third and fourth terminals and having series connected solid-state switching elements connected at a third junction;
a fourth switch ladder bridging the third and fourth terminals and having series connected solid-state switching elements connected at a fourth junction;
a first coupling capacitor connected between and isolating the first and third junctions;
a second coupling capacitor connected between and isolating the second and fourth junctions;
at least one current matching capacitor connected between the first junction and the second junction or connected between the third junction and the fourth junction;
a solid-state switching element controller operating the solid-state switching elements to communicate DC power from the first and second terminals to the third and fourth terminals; and
wherein the first and second junctions and the third and fourth junctions each face a capacitive load.

2. The capacitive bridge transformer of claim 1 further including a current matching capacitor connected between both of the first junction and the second junction and at least one current matching capacitor connected between the third junction and the fourth junction.

3. The capacitive bridge transformer of claim 2 wherein the capacitor bridge transformer provides at least one of a step up or step down of current between the first and second terminals and the third and fourth terminals.

4. The capacitive bridge transformer of claim 1 further including an input inductor in series with at least one of the first and second terminals providing a current stiff input current.

5. The capacitive bridge transformer of claim 4 further including an output inductor in series with at least one of the third and fourth terminals providing an impedance providing a current stiff output current.

6. The capacitive bridge transformer of claim 1 further including a fifth switch ladder bridging the first and second terminals and having series connected solid-state elements switching connected at a fifth junction;
and a sixth switch ladder bridging the third and fourth terminals and having series connected solid-state switching elements connected at a sixth junction;
a third coupling capacitor connected between and isolating the fifth and sixth junctions;
at least one current matching capacitor connected between each pair of different junctions selected from the first junction, the second junction, and the fifth junction, or at least one current matching capacitor connected between each pair of different junctions selected from the third junction, the fourth junction and the sixth junction;
wherein the solid-state switching element controller further operates the solid-state switching elements of the fifth switch ladder and sixth switch ladder to communicate DC power from the first and second terminals to the third and fourth terminals.

7. The capacitive bridge transformer of claim 6 further at least one current matching capacitor connected between each pair of different junctions selected from the first junction, the second junction, and the fifth junction and at least one current matching capacitor connected between each pair of different junctions selected from the third junction, the fourth junction and the sixth junction.

8. The capacitive bridge transformer of claim 7 wherein the current matching capacitors are connected in a Δ configuration.

9. The capacitive bridge transformer of claim 1 further including a third coupling capacitor connected between and isolating the first and fourth junctions;
a fourth coupling capacitor connected between and isolating the second and third junctions.

10. The capacitive bridge transformer of claim 1 further including a fifth and sixth terminal;
a fifth switch ladder bridging the fifth and sixth terminals and having series connected solid-state switching elements connected at a fifth junction;
a sixth switch ladder bridging the fifth and sixth terminals and having series connected solid-state elements switching connected at a sixth junction;
a fifth coupling capacitor connected between and isolating the fifth and first junctions;
a sixth coupling capacitor connected between and isolating the sixth and second junctions;
a solid-state switching element controller operating the solid-state switching elements to communicate DC power between the first and second terminals and the fifth and sixth terminals; and wherein the fifth and sixth junctions face a capacitive impedance.

11. The capacitive bridge transformer of claim 1 where in the solid-state switching elements are bidirectional.

12. The capacitive bridge transformer of claim 1 wherein the solid-state switching element controller measures a current input at one of the first and second terminals and a current output at one of the third and fourth terminals to operate the solid-state switching elements.

13. The capacitive bridge transformer of claim 1 wherein the solid-state switching element controller switches the solid-state switching elements at a frequency in excess of 2 kHz.

14. The capacitive bridge transformer of claim 1 wherein the switching elements are selected from a pair of back to back unidirectional transistors and a transistor.

15. The capacitive bridge transformer of claim 1 wherein the first and second terminals are galvanically isolated from the third and fourth terminals.

16. The capacitive bridge transformer of claim 1 wherein the solid-state switching element controller operates the solid-state switching elements to provide a bidirectional power flow at different times between the first and second terminals to or from the third and fourth terminals.

17. The capacitive bridge transformer of claim 1 wherein the solid-state switching elements are bidirectional insulated gate bipolar transistors or metal oxide silicon field effect transistors or high-electron-mobility transistors or junction field-effect transistors.
